(19) United States
(12) Patent Application Publication
(10) Pub. No.: US 2006/0104177 A1
(43) Pub. Date: May 18, 2006

(54) Defect detection circuit

(75) Inventor: Nobuyuki Mitsui, Itami-shi (JP)

Correspondence Address: STEPTOE & JOHNSON LLP, 1330 CONNECTICUT AVE., NW, WASHINGTON, DC, 20036, US

(73) Assignee: Matsushita Electric Industrial Co., LTD., Kadoma-shi (JP)

(21) Appl. No.: 11/255,985

(22) Filed: Oct. 24, 2005

(30) Foreign Application Priority Data
Nov. 17, 2004 (JP) 2004-332526

(51) Int. Cl. G11B 7/09

(52) U.S. Cl. 369/53.15

(57) ABSTRACT

A defect detection circuit capable of accurately and rapidly detecting a defect regardless of the operating speed of an optical disk unit. During high-multiplied-speed operation of the optical disk unit, an output duration t1 of a mono-multi signal MM1 output from a mono-multi circuit (11) for turning on a switch (6) is set by a mono-multi time adjustment device (9) to a shorter time, thereby to shorten the time period t1 during which a time constant of an integration circuit (3) is reduced after the operation of the optical disk unit is changed from recording operation to reproducing operation.

### FIELD OF THE INVENTION

The present invention relates to a defect detection circuit for detecting a defect on an optical disk.

### BACKGROUND OF THE INVENTION

In recent years, with the remarkable increase in amount of information, optical disk units having a large capacity, having a high read/write speed and capable of random access have been put to use as information data recording/reproduction devices in computer systems. As recording media, optical disks such as a compact disc-recordable (CD-R), a CD-rewritable (CD-RW), a digital versatile disc-recordable/rewritable (DVD-R/RW) and a DVD-random access memory (DVD-RAM) are being used.

Such optical disk units incorporate a defect detection circuit for detecting a defect in an optical disk, which is a region in the optical disk where write or read is not normally performed. The defect detection circuit detects a defect by detecting a change in an envelope of a reflection signal obtained in response to the intensity of reflected light obtained from a light beam applied to and converged on the optical disk, and outputs a defect detection signal indicating the existence/nonexistence of a defect (see, for example, Japanese Patent Laid-Open No. 2003-196853).

The defect detection signal is used, for example as a signal for holding a preceding value in tracking servo circuit for making a laser spot follow a center of a track on an optical disk and a focus servo circuit for focusing of a laser spot on a disk recording surface, and as a signal for obtaining an extracted signal for determination of a recording impossible region of an optical disk in a central processing unit (CPU) for various kinds of control incorporated in an optical disk unit.

A conventional defect detection circuit will be described with reference to FIG. 7 showing the configuration of the defect detection circuit. Referring to FIG. 7, a variable-gain amplifier 1 amplifies a reflection signal AS generated from reflected light obtained from a light beam applied to an optical disk at a predetermined gain according to a recording gate signal WTGT indicating whether the present operation of the optical disk unit incorporating the defect detection circuit is recording operation or reproducing operation, and outputs the amplified signal. The following description is made by assuming that the signal level of the recording gate signal WTGT becomes high level when recording operation is performed and becomes low level when reproducing operation is performed.

A high-speed envelope detection circuit 2 detects an envelope of the reflection signal AS amplified by the variable-gain amplifier 1 (hereinafter referred to as “amplifier output signal AP”) and outputs an envelope signal EM.

An integration circuit 3 integrates the envelope signal EM from the high-speed envelope detection circuit 2 with a variable time constant and outputs a signal IS. As shown in FIG. 7, the integration circuit 3 has a resistor 4, a capacitor 5, and a switch 6 connected in parallel with the resistor 4. The envelope signal EM is applied to one end of the resistor 4. The other end of the resistor 4 is connected to a slice level setting circuit 7 and to one end of the capacitor 5. The other end of the capacitor 5 is grounded.

The switch 6 is controlled by a pulse signal MM2 of a certain duration output from a mono-multi circuit 11. The switch 6 is set so as to be on when the level of the pulse signal MM2 is high level, and off when level of the pulse signal MM2 is low level. The time constant of the integration circuit 3 can be varied by turning on or off the switch 6. That is, the time constant of the integration circuit 3 when the switch 6 is on is smaller than a predetermined time constant determined by the resistor 4 and the capacitor 5.

The slice level setting circuit 7 sets a slice level SD for detection of a defect on an optical disk with reference to the output signal IS from the integration circuit 3. A comparator 8 compares the slice level SD and the level of the envelope signal EM output from the high-speed envelope detection circuit 2 and generates a defect detection signal DD indicating the existence/nonexistence of a defect.

An edge detection circuit 10 detects from a change in level of the recording gate signal WTGT a change in the operation of the optical disk unit from recording operation to reproducing operation or from reproducing operation to recording operation, and outputs a detection signal. The mono-multi circuit 11 receives the detection signal output from the edge detection circuit 10 and outputs the pulse signal MM2 of the certain duration to the integration circuit 3.

The operation of the thus-arranged conventional defect detection circuit will be described with reference to FIGS. 7 and 8. FIG. 8 shows the waveforms of the output signals in the defect detection circuit.

In ordinary cases of recording on optical disks in optical disk units, data is recorded, for example, by reading out address information recorded on the optical disk and by searching for a target address region. That is, reproducing operation and recording operation are repeated during data recording. Since the intensity of light applied to an optical disk during recording operation and the intensity of light applied to the optical disk during reproducing operation are different from each other, reflection signal AS changed in signal level as shown in FIG. 8 is input to the variable-gain amplifier 1 during data recording.

The variable-gain amplifier 1 amplifies the reflection signal AS at a predetermined gain according to the operation of the optical disk unit on the basis of the recording gate signal WTGT to equalize the level of the amplifier output signal AP between recording operation and reproducing operation in order to prevent a difference in level of the reflection signal AS from being detected as a change in the envelope.

In a case where the variable gain amplifier 1 does not have the suitable set gain due to a variation in the gain setting for example, a difference in level occurs in the amplifier output signal AP between recording operation and reproducing operation, as shown in FIG. 8.

The high-speed envelope detection circuit 2 detects the envelope of the input amplifier output signal AP and outputs the envelope signal EM to the integration circuit 3 and to the comparator 8. The integration circuit 3 integrates the envelope signal EM from the high-speed envelope detection circuit 2 and outputs the signal IS to the slice level setting circuit 7.

After the operation of the optical disk unit has been changed from reproducing operation to recording operation, or during a certain time period t2 after the operation of the optical disk unit has been changed from recording operation to reproducing operation, the integration circuit 3 integrates the envelope signal EM by performing an operation for reducing the time constant as described below.

First, the edge detection circuit 10 detects a change in level of the recording gate signal WTGT from low level to high level or from high level to low level, and outputs the detection signal to the mono-multi circuit 11.

The mono-multi circuit 11 receives the detection signal from the edge detection circuit 10, generates pulse signal MM2 having the high signal level during the certain time period t2, and outputs the pulse signal MM2 to the switch 6 in the integration circuit 3.

In response to the change to high level of the pulse signal MM2 from the mono-multi circuit 11, the switch 6 becomes on. When the switch 6 becomes on, the resistor 4 is shorted to reduce the time constant of the integration circuit 3. During the time period t2 during which the level of the pulse signal MM2 from the mono-multi circuit 11 is high level, therefore, the integration circuit 3 integrates the envelope signal EM with a time constant smaller than the normal value and outputs the output signal IS to the slice level setting circuit 7 in the following stage.

During periods other than the certain period t2, the level of the pulse signal from the mono-multi circuit 11 is low level and the switch 6 in the integration circuit 3 is off. Under this condition, the integration circuit 3 integrates the envelope signal EM with the predetermined time constant determined by the resistor 4 and the capacitor 5 and outputs the output signal IS to the slice level setting circuit 7 in the following stage.

The slice level setting circuit 7 sets the slice level SD by converting the output signal IS from the integration circuit 3 and outputs the slice level SD to the comparator 8. The comparator 8 binarizes the envelope signal EM output from the high-speed envelope detection circuit 2 with reference to the slice level SD and outputs the binarized signal as defect detection signal DD.

That is, during periods other than the certain period t2, the envelope signal EM is integrated with the predetermined time constant; a change in the output signal IS from the integration circuit 3 follows a change in the envelope signal EM with a delay from the same; and the level of the envelope signal EM becomes lower than the slice level SD at a defect to form a defect signal TS1 (true defect signal) indicating the existence of the defect, the defect signal TS1 being output during the period corresponding to the defect.

In a case where a change in level of the envelope signal EM occurs between reproducing operation and recording operation due to a variation in the gain setting of the variable-gain amplifier 1 for example, the level of the envelope signal EM also becomes lower than the slice level SD after the operation of the optical disk unit has been changed from recording operation to reproducing operation, as shown in FIG. 8. In this defect detection circuit, however, the envelope signal EM is integrated by reducing the time constant of the integration circuit 3 during the certain time period t2 after changing from recording operation to reproducing operation. Therefore, the change in waveform of the output signal IS from the integration circuit 3 can rapidly follow the change in the envelope signal EM so that the time period during which the defect signal FS1 (false defect signal) is output is shorter than the time period during which the defect signal TS1 is output.

Accordingly, settings are made in the tracking servo circuit, the focus servo circuit and the CPU such that false defect signals of a short output duration are not used, thus realizing an accurate tracking servo operation or the like even in a case where a change in level of the envelope signal EM occurs between reproducing operation and recording operation due to a variation in the gain setting of the variable amplifier 1 for example.

During high-multiplied-speed operation shown in FIG. 9, however, each status is compressed along the time axis in comparison with that is the normal recording operation shown in FIG. 8, so that, even in the case of recording data on the same optical disk, the time period from a change from recording operation to reproducing operation to a point at which a defect is reached is reduced in comparison with that in the ordinary recording operation, and it is possible that a defect which can be detected with accuracy in the ordinary recording operation will appear during the certain time period t2.

If a defect appears during the certain time period t2 during which the time constant is smaller, the output signal IS from the integration circuit 3 rapidly follows the change in waveform of the envelope signal EM due to the defect and the time period during which the level of the envelope signal EM becomes extremely short. In such a situation, there is a possibility of output of a defect signal FS2 (false defect signal) having an output duration shorter than that of the defect signal (true defect signal) to be output.

Thus, in the conventional defect detection circuit, the time period during which the time constant is reduced is fixed. Therefore, if each status is compressed along the time axis due to high-multiplied-speed operation, there is a possibility of output of a defect signal of a shorter output duration for a defect from which the true defect signal can be output in the ordinary operation.

### DISCLOSURE OF THE INVENTION

In view of the above-described problem, an object of the present invention is to provide a defect detection circuit for an optical disk unit in which the time period (mono-multi time) during which a signal for turning on a switch (a signal for reducing a time constant) is output from a mono-multi circuit (mono-multi device) is adjusted according to an operating multiplied speed (operating speed) to enable a defect to be detected in a short time with accuracy regardless of the operating speed of the optical disk unit.

According to a first aspect of the present invention, there is provided a defect detection circuit incorporated in an optical disk unit which makes data access to an optical disk, the defect detection circuit including an amplification device which amplifies a reflection signal generated from reflected light obtained from a light beam applied to the optical disk at a gain according to a recording gate signal indicating whether the present operation of the optical disk unit is recording operation or reproducing operation, and which outputs the amplified signal, an envelope detection device which detects an envelope of the reflection signal amplified by the amplification device, and which outputs an envelope signal, an integration device which integrates the envelope signal from the envelope detection device with a variable time constant, and which outputs the integration result, a slice level setting device which sets a slice level for detection of a defect on the optical disk with reference to the output signal from the integration device, a defect detection signal generation device which compares the level of the envelope signal from the envelope detection device and the slice level, and which generates a defect detection signal indicating the existence/nonexistence of a defect, a mono-multi time adjustment device which adjusts, according to the operating speed of the optical disk, a mono-multi time determining an output duration of the signal for reducing the time constant of the integration device, an operation change detection device which detects from the recording gate signal a change in the operation of the optical disk unit from recording operation to reproducing operation or from reproducing operation to recording operation, and which outputs a detection signal, and a mono-multi device which receives the detection signal from the operation change detection device and outputs the signal for reducing the time constant for the mono-multi time adjusted by the mono-multi time adjustment device.

According to a second aspect of the present invention, there is provided a defect detection circuit incorporated in an optical disk unit which makes data access to an optical disk, the defect detection circuit including an amplification device which amplifies a reflection signal generated from reflected light obtained from a light beam applied to the optical disk at a gain according to a recording gate signal indicating whether the present operation of the optical disk unit is recording operation or reproducing operation, and which outputs the amplified signal, an envelope detection device which detects an envelope of the reflection signal amplified by the amplification device, and which outputs an envelope signal, an integration device which integrates the envelope signal from the envelope detection device with a variable time constant, and which outputs the integration result, a slice level setting device which sets a slice level for detection of a defect on the optical disk with reference to the output signal from the integration device, a defect detection signal generation device which compares the level of the envelope signal from the envelope detection device and the slice level, and which generates a defect detection signal indicating the existence/nonexistence of a defect, a count adjustment device which adjusts a count determining an output duration of the signal for reducing the time constant of the integration device according to the operating speed of the optical disk unit, an operation change detection device which detects from the recording gate signal a change in the operation of the optical disk unit from recording operation to reproducing operation or from reproducing operation to recording operation, and which outputs a detection signal, and a counter device which receives the detection signal from the operation change detection device, counts the number of clock pulses in a predetermined clock signal, and outputs the signal for reducing the time constant for a time period corresponding to the count adjusted by the count adjustment device.

Preferably, in the defect detection circuit according to the second aspect, the predetermined clock signal is a system clock signal for the optical disk unit.

Preferably, in the defect detection circuit according to the second aspect, the predetermined clock signal is a clock signal extracted from a signal obtained from reflected light obtained from the light beam applied to the optical disk.

According to the present invention, the time period (mono-multi time) during which the time constant of the integration device is reduced after changing the operation of the optical disk unit from reproducing operation to recording operation or from recording operation to reproducing operation is made variable, thereby enabling a defect to be accurately and rapidly detected regardless of the operating speed of the optical disk unit. Therefore, the defect detection circuit can accurately detect even a defect which appears immediately after a change in the operation of the optical disk unit from recording operation to reproducing operation (a defect which appears during the certain time period t2 in the conventional circuit) during high-multiplied-speed operation.

### BRIEF DESCRIPTION OF THE DRAWINGS

FIG. 1 is a block diagram showing the configuration of a defect detection circuit in Embodiment 1 of the present invention;

FIG. 2 is a diagram showing the waveforms of output signals in the defect detection circuit in Embodiment 1;

FIG. 3 is a block diagram showing the configuration of a defect detection circuit in Embodiment 2 of the present invention;

FIG. 4 is a diagram showing the waveforms of output signals in the defect detection circuit in Embodiment 2;

FIG. 5 is a block diagram showing the configuration of a defect detection circuit in Embodiment 3 of the present invention;

FIG. 6 is a diagram showing the waveforms of output signals in the defect detection circuit in Embodiment 3;

FIG. 7 is a block diagram showing the configuration of a conventional defect detection circuit;

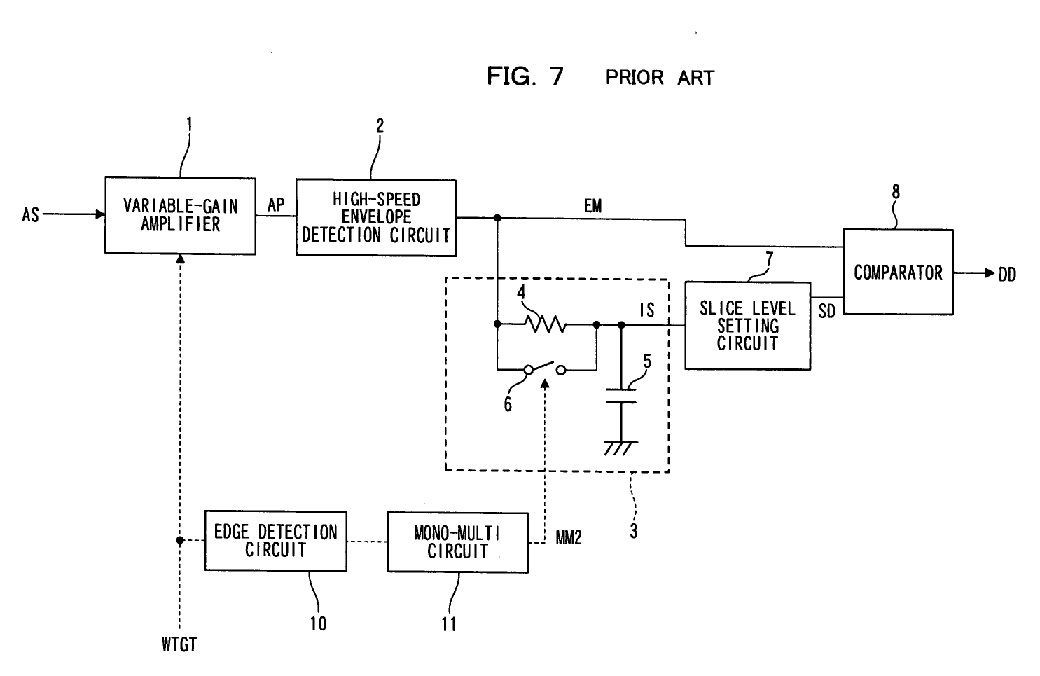

FIG. 8 is a diagram showing the waveforms of output signals in the conventional defect detection circuit; and

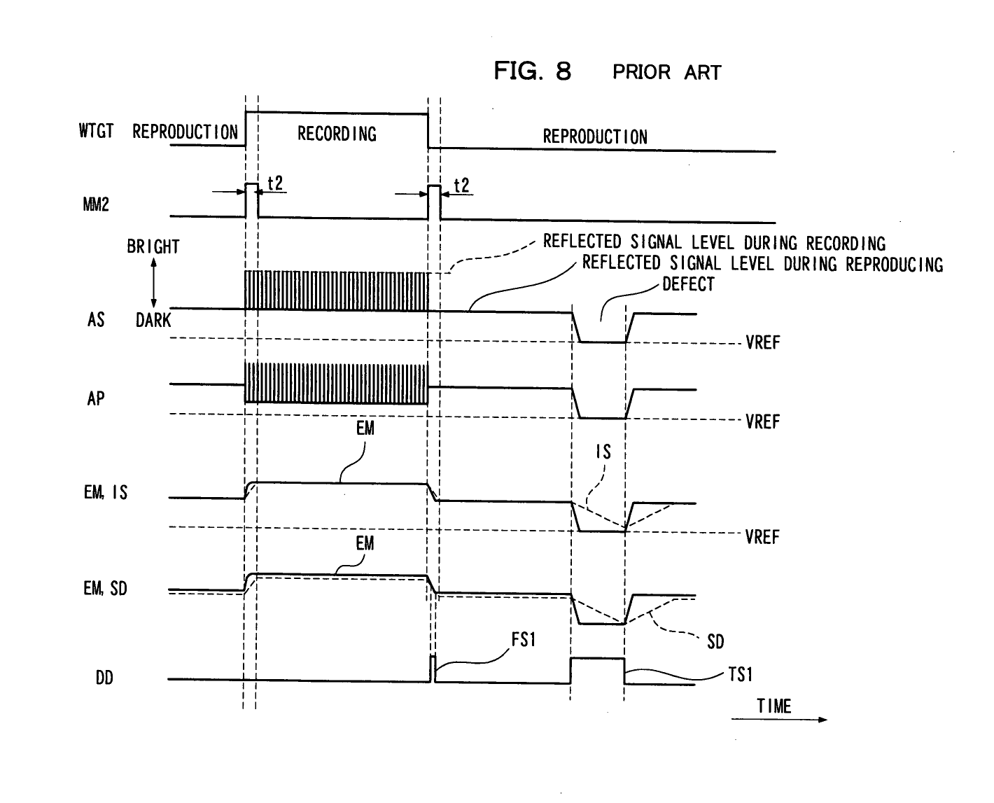

FIG. 9 is a diagram showing the waveforms of the output signals in the conventional defect detection circuit.

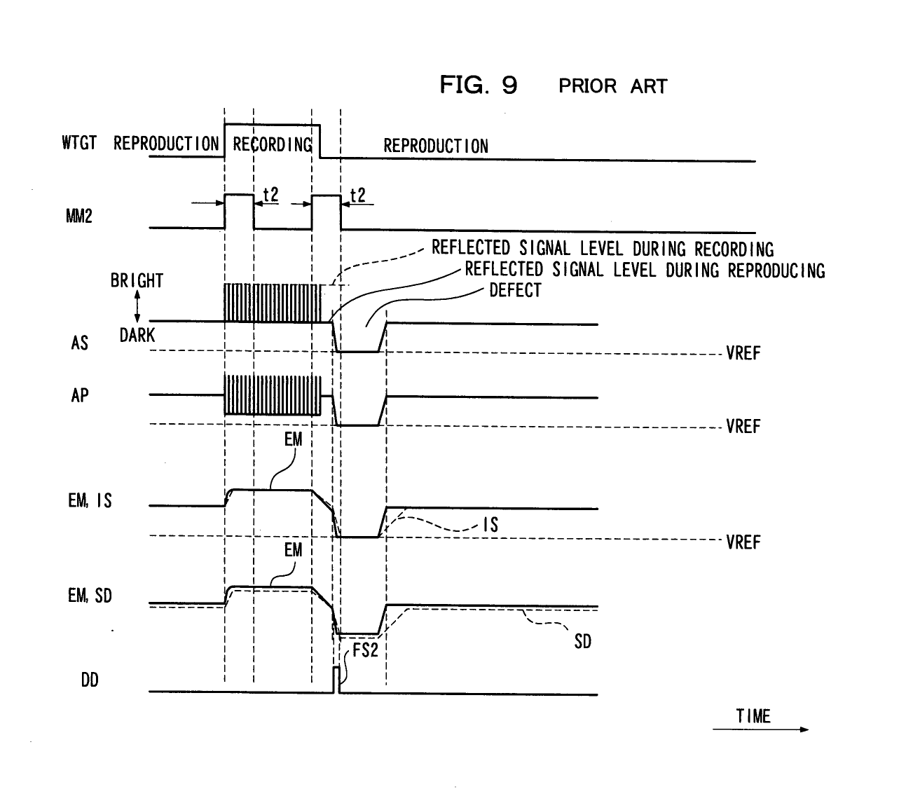

### DESCRIPTION OF THE EMBODIMENTS

Defect detection circuits in embodiments of the present invention will be described below.

### Embodiment 1

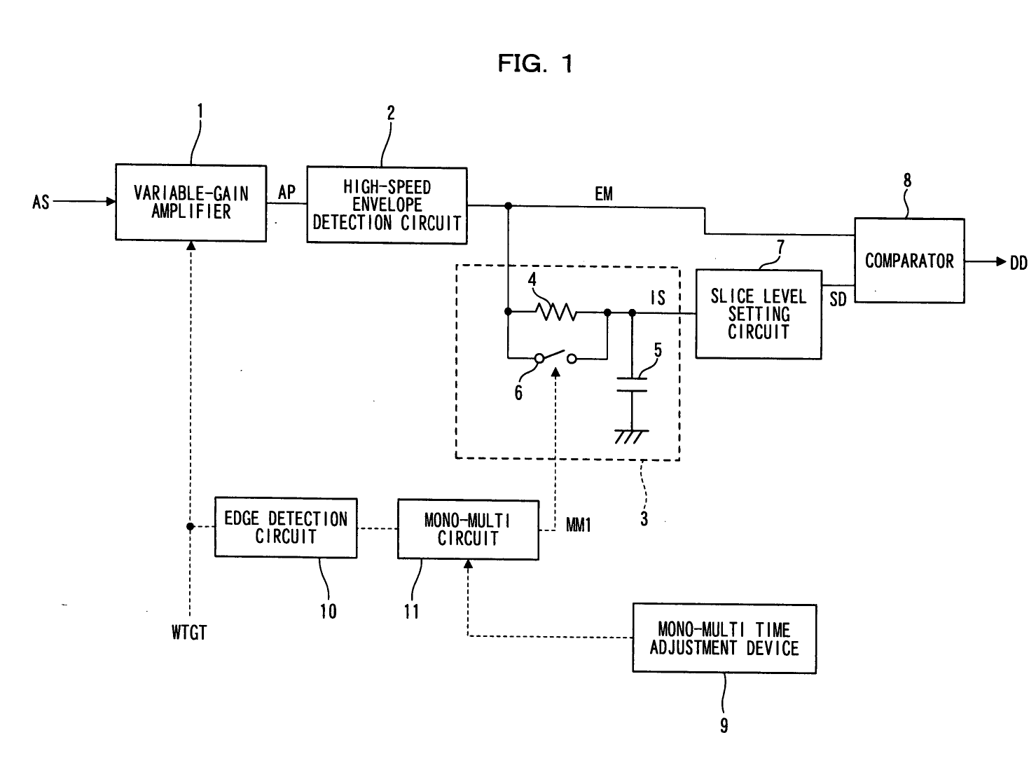

FIG. 1 is a block diagram showing the configuration of a defect detection circuit in Embodiment 1 of the present invention. The defect detection circuit is incorporated in an optical disk unit which performs at least date recording on an optical disk.

Referring to FIG. 1, a variable-gain amplifier (amplification device) 1 amplifies a reflection signal AS generated from reflected light obtained from a light beam applied to an optical disk at a predetermined gain according to a recording gate signal WTGT indicating whether the present operation of the optical disk unit incorporating the defect detection circuit is recording operation or reproducing operation, and outputs the amplified signal. The following description is made by assuming that the signal level of the recording gate signal WTGT becomes high level when recording operation is performed and becomes low level when reproducing operation is performed.

A high-speed envelope detection circuit (envelope detection device) 2 detects an envelope of the reflection signal AS (amplifier output signal AP) amplified by the variable-gain amplifier 1 and outputs an envelope signal EM. The high-speed envelope detection circuit 2, which is an ordinary detection circuit, obtains an upper envelope of the amplifier output signal AP from the variable-gain amplifier and outputs the envelope signal.

An integration circuit (integration device) 3 integrates the envelope signal EM from the high-speed envelope detection circuit 2 with a variable time constant and outputs a signal IS. As shown in FIG. 1, the integration circuit 3 has a resistor 4, a capacitor 5, and a switch 6 connected in parallel with the resistor 4. The envelope signal EM is applied to one end of the resistor 4. The other end of the resistor 4 is connected to a slice level setting circuit 7 and to one end of the capacitor 5. The other end of the capacitor 5 is grounded.

The switch 6 is controlled by a mono-multi signal MM1 output from a mono-multi circuit 11. The time constant of the integration circuit 3 can be changed by turning on or off the switch 6. That is, the time constant of the integration circuit 3 when the switch 6 is on is smaller than a predetermined time constant determined by the resistor 4 and the capacitor 5.

The slice level setting circuit (slice level setting device) 7 sets a slice level SD for detection of a defect on an optical disk with reference to the output signal IS from the integration circuit 3.

A comparator (defect detection signal generation device) 8 compares the slice level SD and the level of the envelope signal EM output from the high-speed envelope detection circuit 2 and generates a defect detection signal DD indicating the existence/nonexistence of a defect.

A mono-multi time adjustment device 9 adjusts a mono-multi time determining the output duration of signal for reducing the time constant of the integration circuit 3, i.e., the signal for turning on the switch 6, according to the operating multiplied speed (operating speed) of the optical disk unit. The mono-multi time adjustment device 9 may be arranged to adjust the mono-multi time, for example, on the basis of multiplied speed information set in the optical disk unit.

An edge detection circuit (operation change detection device) 10 detects from a change in level of the recording gate signal WTGT a change in the operation of the optical disk unit from recording operation to reproducing operation or from reproducing operation to recording operation, and outputs a detection signal.

The mono-multi circuit 11 receives the detection signal output from the edge detection circuit 10 and outputs the mono-multi signal MM1 for turning on the switch 6 to the integration circuit 3 during the mono-multi time adjusted by the mono-multi time adjustment device 9. The following description will be made by assuming that the mono-multi signal MM1 is a pulse signal, and that the switch 6 is on when this pulse signal is high level. In this embodiment, therefore, the mono-multi time corresponds to the pulse width of the pulse signal.

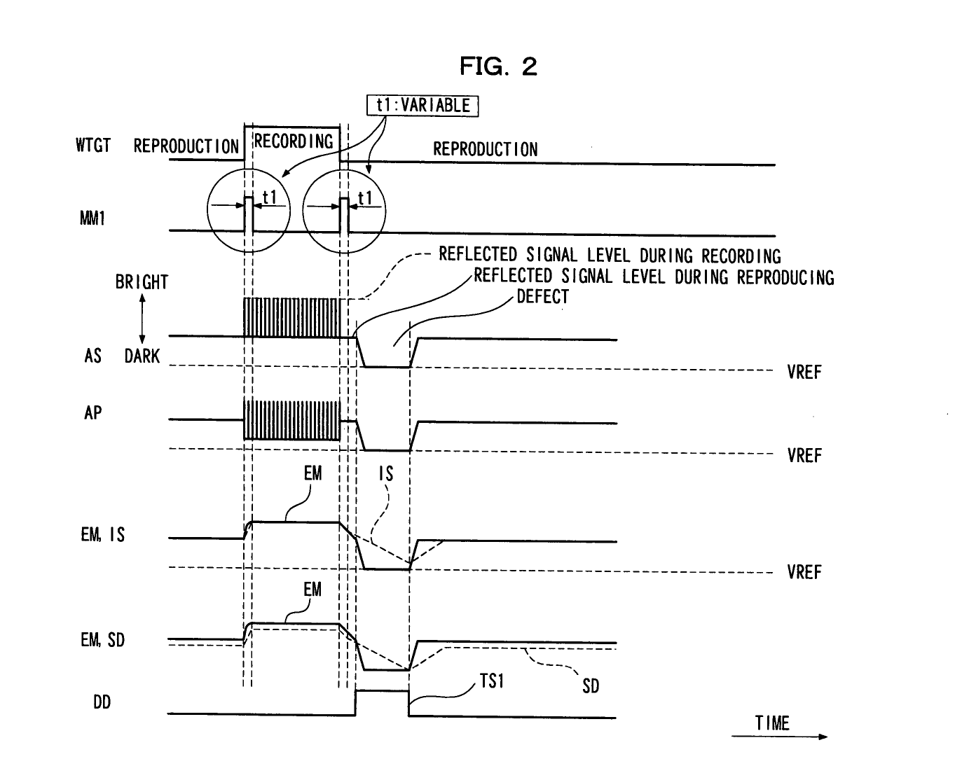

The operation of the thus-arranged defect detection circuit will be described with reference to FIGS. 1 and 2. FIG. 2 shows the waveforms of the output signals in the defect detection circuit.

First, a plurality of light receiving elements (not shown) receive reflected light obtained from a light beam applied to and converged on an optical disk, convert the light into electrical signals changing in level according to the amount of reflected light, and output the electrical signals. The electrical signals output from the plurality of light receiving elements are added together to obtain a total addition signal, which is input as a reflection signal AS to the variable-gain amplifier 1.

In ordinary cases of recording on optical disks in optical disk units, data is recorded, for example, by reading out address information recorded on the optical disk and by searching for a target address region. That is, reproducing operation and recording operation are repeated during data recording. Since the intensity of light applied to an optical disk during recording operation and the intensity of light applied to the optical disk during reproducing operation are different from each other, reflection signal AS changed in signal level as shown in FIG. 2 is input to the variable-gain amplifier 1 during data recording.

When the level of the recording gate signal WTGT input to the variable-gain amplifier 1 is low level, the variable-gain amplifier 1 determines that the present operation of the optical disk unit is reproducing operation, amplifies the reflection signal AS at a gain for reproducing operation, and outputs the amplifier output signal AP.

When the level of the recording gate signal WTGT input to the variable-gain amplifier 1 is high level, the variable-gain amplifier 1 amplifies the reflection signal AS by setting a gain lower than that at the time of reproducing operation and outputs the amplifier output signal AP.

Thus, the variable-gain amplifier 1 amplifies the reflection signal AS at the predetermined gain according to the operation of the optical disk unit on the basis of the recording gate signal WTGT to equalize the level of the amplifier output signal AP between recording operation and reproducing operation in order to prevent a difference in level of the reflection signal AS from being detected as a change in the envelope.

In a case where the variable gain amplifier 1 does not have the suitable set gain due to a variation in the gain setting for example, a difference in level occurs in the amplifier output signal AP between recording operation and reproducing operation, as shown in FIG. 2.

The high-speed envelope detection circuit 2 detects the upper envelope of the input amplifier output signal AP and outputs the envelope signal EM to the integration circuit 3. The integration circuit 3 integrates the envelope signal EM with the predetermined time constant determined by the resistor 4 and the capacitor 5 and outputs the signal IS to the slice level setting circuit 7 in the following stage. After the operation of the optical disk unit has been changed from reproducing operation to recording operation, or during a certain time period t1 (mono-multi time) after the operation of the optical disk unit has been changed from recording operation to reproducing operation, however, the integration circuit 3 integrates the envelope signal EM by performing an operation for reducing the time constant as described below.

First, the edge detection circuit 10 detects a change in level of the recording gate signal WTGT from low level to high level or from high level to low level, and outputs the detection signal to the mono-multi circuit 11.

The mono-multi circuit 11 receives the detection signal from the edge detection circuit 10, generates mono-multi signal MM1 for turning on the switch 6 (pulse signal having high signal level) during the time period t1 (mono-multi time) set by the mono-multi time adjustment device 9, and outputs the mono-multi signal MM1 to the switch 6.

The switch 6 becomes on by receiving the mono-multi signal MM1 from the mono-multi circuit 11. When the switch 6 becomes on, the resistor 4 is shorted to reduce the time constant of the integration circuit 3. During the time period t1 during which the mono-multi signal MM1 for turning on the switch 6 (pulse signal having high signal level) is output from the mono-multi circuit 11, therefore, the integration circuit 3 integrates the envelope signal EM with a time constant smaller than the normal value and outputs the output signal IS to the slice level setting circuit 7 in the following stage.

After a lapse of the time period t1, the level of the mono-multi signal MM1 from the mono-multi circuit 11 becomes low level and the switch 6 in the integration circuit 3 becomes off. Accordingly, the integration circuit 3 again integrates the envelope signal EM with the predetermined time constant and outputs the output signal IS to the slice level setting circuit 7.

In the time period t1, the change in waveform of the output signal IS from the integration circuit 3 rapidly follows the change in waveform of the envelope signal EM, as shown in FIG. 2. In other periods, however, the change in waveform of the output signal IS follows the change in waveform of the envelope signal EM with a delay from the same since the time constant is large.

The mono-multi time t1 set by the mono-multi time adjustment device 9 is adjusted so as to be shorter with the increase in the operating multiplied speed of the optical disk unit to double speed, quadruple speed, to eight-fold speed, and so on. That is, the mono-multi time t1 is adjusted so that the pulse width of the pulse signal MM1 for turning on the switch 6 becomes shorter.

The slice level setting circuit 7 sets the slice level SD with reference to the output signal IS from the integration circuit 3 and outputs the slice level SD to the comparator 8. The slice level SD is set lower than the level of the envelope signal EM at any non-defective portion on the optical disk and higher than the level of the envelope signal EM at a defect.

The comparator 8 binarizes the envelope signal EM output from the high-speed envelope detection circuit 2 with reference to the slice level SD and outputs the binarized signal as defect detection signal DD.

As described above, in the defect detection circuit in Embodiment 1, the time period t1 during which the time constant of the integration circuit after changing the operation of the optical disk unit from recording operation to reproducing operation or from reproducing operation to recording operation is reduced is set shorter in correspondence with a higher operating speed. Therefore, the defect detection circuit is capable of detecting a defect with accuracy even during high-multiplied-speed operation during which each status is compressed along the time axis.

That is, in the conventional defect detection circuit, the period during which the time constant is reduced is fixed. Therefore, if each status is compressed along the time axis due to high-multiplied-speed operation, there is a possibility that a defect which can be detected with accuracy in the ordinary recording operation will appear during the time period during which the time constant is reduced, and that the slice level will immediately become lower than the level of the envelope signal EM at the defect to cause output of a false defect signal of a shorter output duration. In contrast, in the defect detection circuit in Embodiment 1, the period (mono-multi time) during which the time constant is reduced is variable and is reduced during high-multiplied-seed operation to reduce the occurrence of a defect during the time period during which the time constant is reduced, thus making it possible to detect a defect with accuracy.

### Embodiment 2

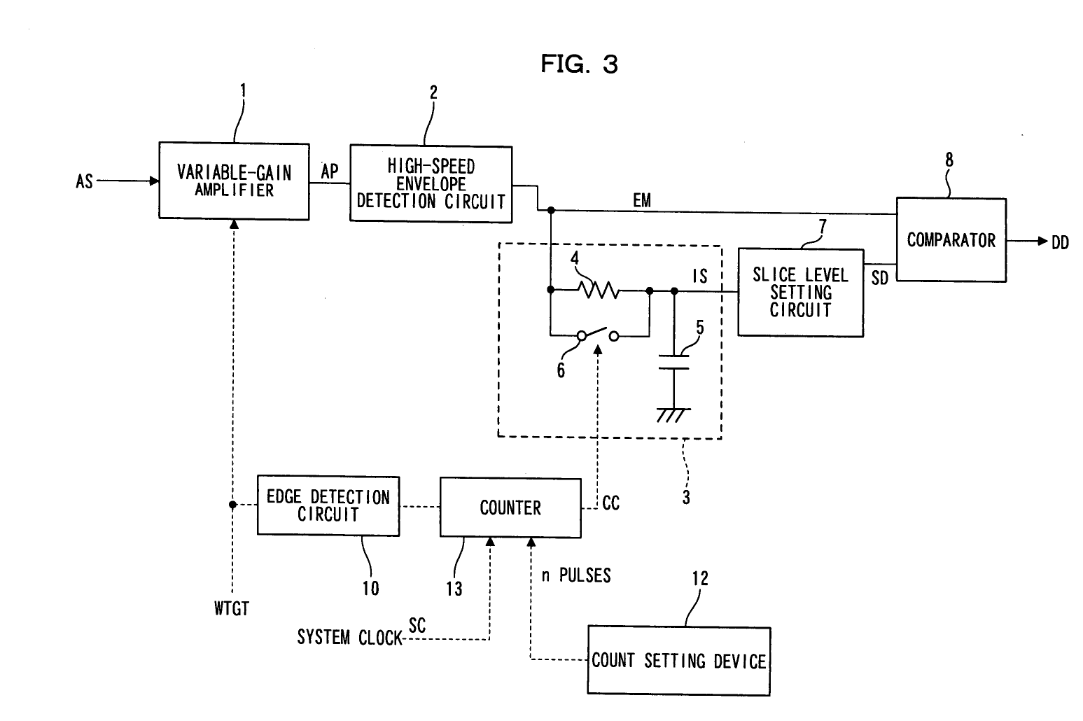

FIG. 3 is a block diagram showing the configuration of a defect detection circuit in Embodiment 2 of the present invention. Components identical or corresponding to those described above with reference to FIG. 1 are indicated by the same reference numerals in FIG. 3, and the description for them will not be repeated.

Referring to FIG. 3, a count setting device (count adjustment device) 12 adjusts a count determining the output duration of the signal for reducing the time constant of the integration circuit 3 according to the operating multiplied speed (operating speed) of the optical disk unit.

A counter (counter device) 13 receives the detection signal from the edge detection circuit 10, counts the number of clock pulses in a system clock signal SC, which is a predetermined clock signal, and outputs the signal for reducing the time constant of the integration circuit 3 for a time period corresponding to the count adjusted and set by the counter setting device 12.

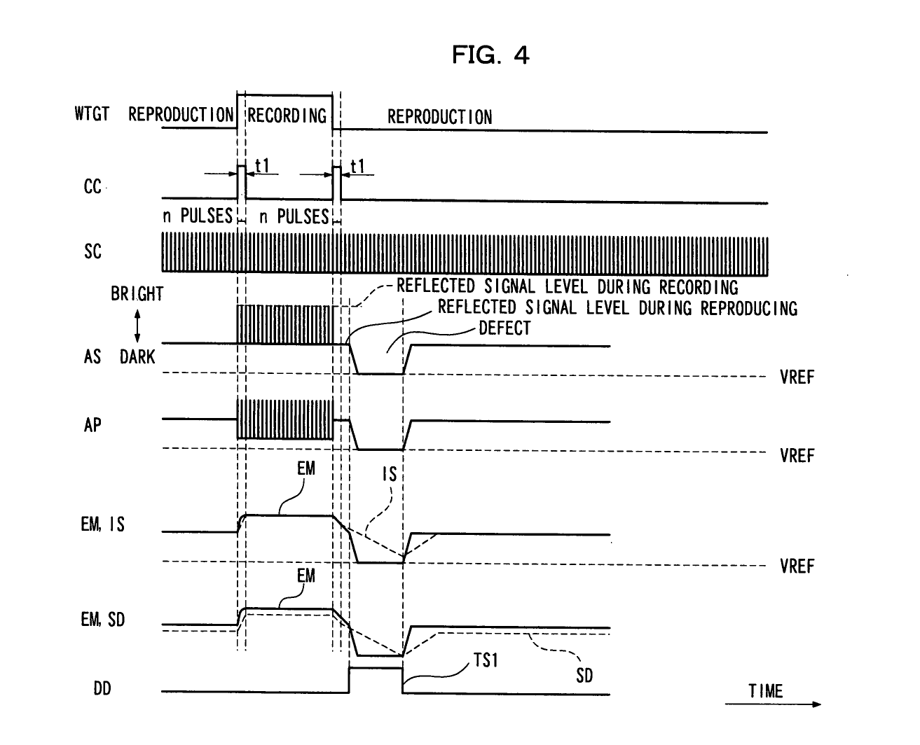

The operation of the thus-arranged defect detection circuit will be described with reference to FIGS. 3 and 4. FIG. 4 shows waveforms of the output signals in the defect detection circuit. The description of the same operation as that of the defect detection circuit in Embodiment 1 described above will not be repeated.

The operation of this defect detection circuit differs from that of the defect detection circuit in Embodiment 1 in the operation to reduce the time constant of the integration circuit in the time period t1 after changing the operation of the optical disk unit from reproducing operation to recording operation or from recording operation to reproducing operation.

First, the edge detection circuit 10 detects a change in level of the recording gate signal WTGT from low level to high level or from high level to low level and outputs the detection signal to the mono-counter 13, as does the corresponding circuit in Embodiment 1.

The counter 13 starts counting the number of clock pulses in the input system clock signal SC in synchronization with the detection signal from the edge detection circuit 10. Until the counter 13 completes counting the number of clock pulses corresponding to the count set by the count setting device 12, it generates mono-multi signal MM1 for turning on the switch 6 (pulse signal having high signal level) and outputs the mono-multi signal MM1 to the switch 6 in the integration circuit 3.

The count set by the count setting device 12 is adjusted so as to be smaller with the increase in the operating multiplied speed of the optical disk unit to double speed, quadruple speed, to eight-fold speed, and so on. That is, the count is adjusted so that the pulse width of the pulse signal MM1 for turning on the switch 6 becomes shorter.

As described above, in the defect detection circuit in Embodiment 2, the signal for reducing the time constant of the integration circuit is generated by counting the number of clock pulses in the system clock signal SC used for control of the optical disk unit. The system clock signal SC is ordinarily generated by a quartz-crystal vibrator or the like. Therefore, this arrangement is capable of accurately setting the time period t1 during which the time constant of the integration circuit is reduced, in comparison with the arrangement in which the time constant reducing signal is generated by using a mono-multi circuit including various causes of variation due to use of certain internal elements.

### Embodiment 3

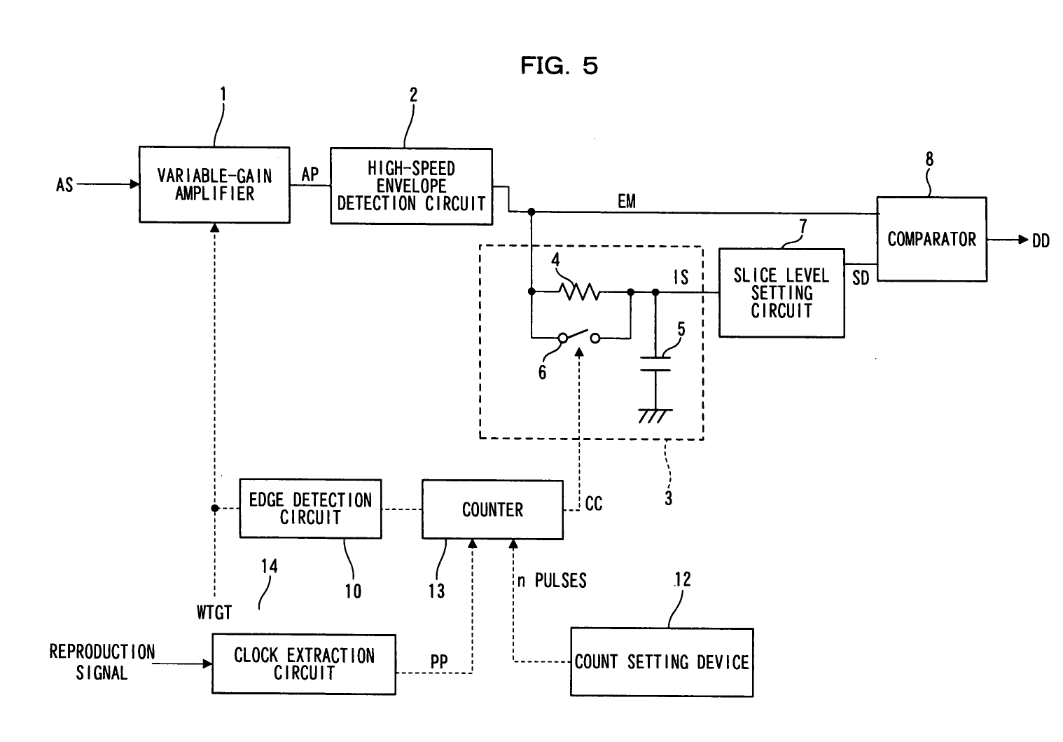

FIG. 5 is a block diagram showing the configuration of a defect detection circuit in Embodiment 3 of the present invention. Components identical or corresponding to those described above with reference to FIGS. 1 and 3 are indicated by the same reference numerals in FIG. 5, and the description for them will not be repeated.

Referring to FIG. 5, a clock extraction circuit (clock extraction device) 14 extracts a clock component from a reproduction signal which is a signal obtained from reflected light obtained from a light beam applied to an optical disk, and outputs a clock signal PP.

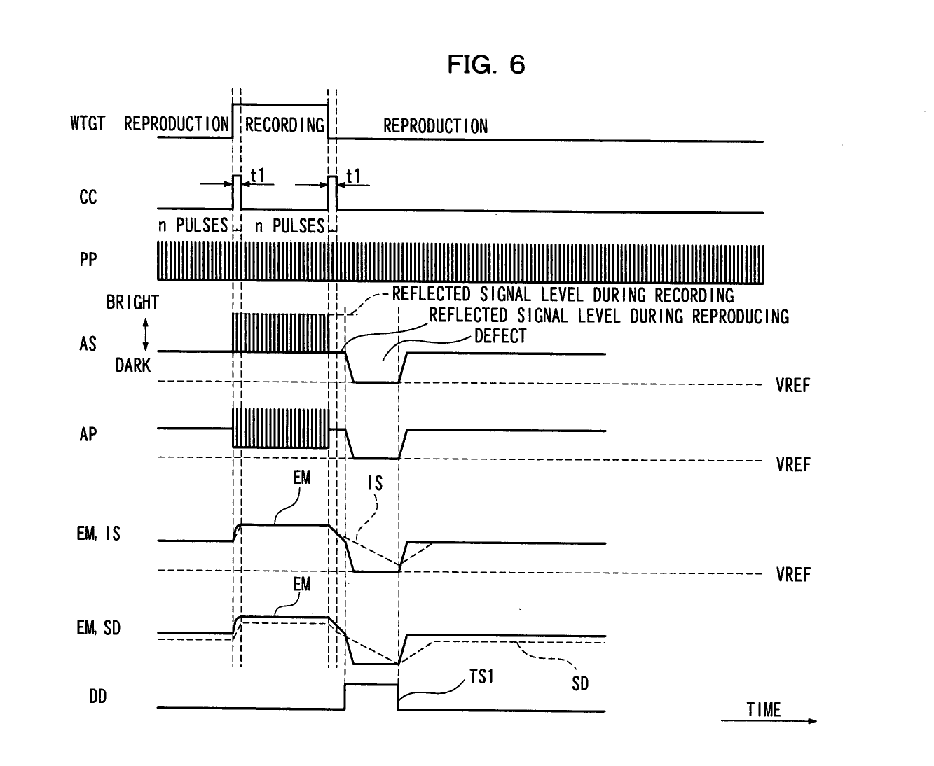

The operation of the thus-arranged defect detection circuit will be described with reference to FIGS. 5 and 6. FIG. 6 shows waveforms of the output signals in the defect detection circuit. The description of the same operation as that of the defect detection circuit in Embodiment 2 described above will not be repeated.

This defect detection circuit differs from the defect detection circuit in Embodiment 2 in that the signal for reducing the time constant of the integration signal is generated by using a clock component extracted from a reproduction signal which is a signal obtained from reflected light obtained from the light beam applied to an optical disk.

First, the edge detection circuit 10 detects a change in level of the recording gate signal WTGT from low level to high level or from high level to low level and outputs the detection signal to the counter 13, as does the corresponding circuit in Embodiment 2.

On the other hand, the clock extraction circuit 14 extracts the lock component from the reproduction signal output at the time of reproduction from the optical disk and outputs the clock signal PP to the counter 13 in the following stage. The counter 13 starts counting the number of clock pulses in the input clock signal PP in synchronization with the detection signal from the edge detection circuit 10. Until the counter 13 completes counting the number of clock pulses corresponding to the count set by the count setting device 12, it generates mono-multi signal MM1 for turning on the switch 6 (pulse signal having high signal level) and outputs the mono-multi signal MM1 to the switch 6 in the integration circuit 3.

The frequency of the clock signal PP obtained from the clock component extracted from the reproduction signal changes with the rotational speed of the optical disk, it includes information on the rotational speed of the optical disk. In Embodiment 3, the count setting device 12 is arranged to determine the count to be set in the counter 13 on the basis of the optical disk rotational speed information in the clock signal PP.

As described above, in the defect detection circuit in Embodiment 3, the signal for reducing the time constant of the integration circuit is generated by using the clock signal PP obtained from the clock component extracted from the reproduction signal. Also, the count to be set in the counter 13 is determined on the basis of optical disk rotational speed information contained in the clock signal PP. Therefore, the time period t1 during which the time constant of the integration circuit is reduced can be suitably set according to the rotational speed without externally providing any special setting.

Each of the defect detection circuits in Embodiments 1 to 3 is capable of accurately detecting even a defect which appears immediately after a change in the operation of the optical disk unit from recording operation to reproducing operation during high-multiplied-speed operation. Thus, the data access operation of the optical disk unit capable of high-multiplied-speed operation is stabilized.

The defect detection circuit in accordance with the present invention can accurately and rapidly detect a defect regardless of the operating speed of an optical disk unit and is useful in an optical disk unit capable of high-multiplied-speed operation.

What is claimed is:

1. A defect detection circuit incorporated in an optical disk unit for making data access to an optical disk, the defect detection circuit comprising:
an amplification device which amplifies a reflection signal generated from reflected light obtained from a light beam applied to the optical disk at a gain according to a recording gate signal indicating whether the present operation of the optical disk unit is recording operation or reproducing operation, and which outputs the amplified signal;
an envelope detection device which detects an envelope of the reflection signal amplified by the amplification device, and which outputs an envelope signal;
an integration device which integrates the envelope signal from the envelope detection device with a variable time constant, and which outputs the integration result;
a slice level setting device which sets a slice level for detection of a defect on the optical disk with reference to the output signal from the integration device;
a defect detection signal generation device which compares the level of the envelope signal from the envelope detection device and the slice level, and which generates a defect detection signal indicating the existence/nonexistence of a defect;
a mono-multi time adjustment device which adjusts, according to the operating speed of the optical disk, a mono-multi time determining an output duration of the signal for reducing the time constant of the integration device;
an operation change detection device which detects from the recording gate signal a change in the operation of the optical disk unit from recording operation to reproducing operation or from reproducing operation to recording operation, and which outputs a detection signal; and
a mono-multi device which receives the detection signal from the operation change detection device and outputs the signal for reducing the time constant for the mono-multi time adjusted by the mono-multi time adjustment device.

2. A defect detection circuit incorporated in an optical disk unit for making data access to an optical disk, the defect detection circuit comprising:
an amplification device which amplifies a reflection signal generated from reflected light obtained from a light beam applied to the optical disk at a gain according to a recording gate signal indicating whether the present operation of the optical disk unit is recording operation or reproducing operation, and which outputs the amplified signal;
an envelope detection device which detects an envelope of the reflection signal amplified by the amplification device, and which outputs an envelope signal;
an integration device which integrates the envelope signal from the envelope detection device with a variable time constant, and which outputs the integration result;
a slice level setting device which sets a slice level for detection of a defect on the optical disk with reference to the output signal from the integration device;
a defect detection signal generation device which compares the level of the envelope signal from the envelope detection device and the slice level, and which generates a defect detection signal indicating the existence/nonexistence of a defect;
a count adjustment device which adjusts a count determining an output duration of the signal for reducing the time constant of the integration device according to the operating speed of the optical disk unit;
an operation change detection device which detects from the recording gate signal a change in the operation of the optical disk unit from recording operation to reproducing operation or from reproducing operation to recording operation, and which outputs a detection signal; and
a counter device which receives the detection signal from the operation change detection device, counts the number of clock pulses in a predetermined clock signal, and outputs the signal for reducing the time constant for a time period corresponding to the count adjusted by the count adjustment device.

3. The defect detection circuit according to claim 2, wherein the predetermined clock signal is a system clock signal for the optical disk unit.

4. The defect detection circuit according to claim 2, wherein the predetermined clock signal is a clock signal extracted from a signal obtained from reflected light obtained from the light beam applied to the optical disk.
